(19) United States
(12) Patent Application Publication
(10) Pub. No.: US 2024/0028119 A1
(43) Pub. Date: Jan. 25, 2024

(54) VEHICLE EXPERIENCE SYSTEM WITHIN A METAVERSE AND METHOD THEREOF

(71) Applicant: Honda Motor Co., Ltd., Tokyo (JP)

(72) Inventors: MATT KOMICH, DENVER, CO (US); CHRISTOPHER JOHN TARCHALA, LOS ANGELES, CA (US)

(21) Appl. No.: 17/869,632

(22) Filed: Jul. 20, 2022

(51) Int. Cl. G06F 3/01; G06T 19/00; G06Q 30/06; G06Q 30/02

(52) U.S. Cl. CPC G06F 3/016; G06F 3/014; G06T 19/003; G06T 19/006; G06Q 30/0643; G06Q 30/0207

(57) ABSTRACT

The present disclosure relates to a virtual world where interactions between computer-generated participants or users may occur. More particularly, this disclosure describes a system within a metaverse that allows the participants to involve themselves in experiencing a vehicle through a dealership environment. In one illustrative embodiment, a metaverse server may be coupled to a client computer through a network with the client computer allowing a user to enter into the metaverse. The metaverse server may open the dealership environment within a metaverse application. The dealership environment may provide at least one vehicle in a context of a multidimensional virtual scene, wherein the at least one vehicle is replicated from a physical vehicle at a dealership. The system may include an object experience engine coupled to the metaverse application which provides interactions with the at least one vehicle from the dealership environment within the metaverse application.

### BACKGROUND

In the metaverse, a virtual world may be generated by a computer that simulates an environment. This environment may be presented in two-dimensional (2D) or three dimensional (3D) formats and may mimic a defined environment through visual and audio cues. For example, the virtual world may be a forest with computer generated trees, streams, and wildlife. Sounds may include wind blowing and birds chirping. City landscapes may also be created which simulate a densely populated city such as New York City.

The virtual worlds may allow for a user to inhabit, traverse, and interact with others within the created environments. The user may immerse themselves through virtual reality (VR) and augmented reality (AR) headsets. Avatars, which are personas of the user, may be placed within the metaverse so that the user actually feels that they are within the environment. Users may continue to exist even when they are not within the metaverse.

The present disclosure provides for a vehicle experience system and method thereof that uses the metaverse to select a vehicle, test drive it, and then purchase or lease it. Other benefits and advantages will become clear from the disclosure provided herein and those advantages provided are for illustration. The statements in this section merely provide the background related to the present disclosure and does not constitute prior art.

### BRIEF DESCRIPTION

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

In accordance with one aspect of the present disclosure, a system is provided. The system may include a client computer coupled to a network and a metaverse server coupled to the client computer through the network. The metaverse server may open an environment within a metaverse application, the environment having at least one virtual object in a context of a multidimensional virtual scene, wherein the at least one virtual object replicates a physical object. The system may also include an object experience engine coupled to the metaverse application, the object experience engine providing interaction with the at least one virtual object for the environment within the metaverse application.

In accordance with another aspect of the present disclosure, a computer program product having a non-transitory computer useable storage medium to store a computer readable program is provided. The computer readable program, when executed on a computer, causes the computer to perform operations. The operations may include storing information of at least one vehicle scanned in from a physical world vehicle, the stored information associated with a dealership environment within a metaverse application. In addition, the operations may include receiving an event within the metaverse application regarding the at least one vehicle provided by the dealership environment and providing an experience within the metaverse application regarding the at least one vehicle from the dealership environment in response to the event.

In accordance with yet another aspect of present disclosure, a metaverse server is provided. The metaverse may include an environment within a metaverse application, the environment including at least one virtual object. The at least one virtual object may replicate a physical object. The metaverse server may also include an object experience engine coupled to the metaverse application, the object experience engine providing interaction with the at least one virtual object in the metaverse application.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing FIGURES are not necessarily drawn to scale and certain FIGURES may be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a schematic diagram of an illustrative metaverse whereby a potential buyer queries for information regarding a new vehicle in accordance with one aspect of the present disclosure;

FIG. 2 is a schematic diagram of the illustrative metaverse where geographically proximate dealerships provide information regarding the new vehicle in accordance with one aspect of the present disclosure;

FIG. 3 is a schematic diagram of the illustrative metaverse after selection of a dealership by the potential buyer in accordance with one aspect of the present disclosure;

FIG. 4 is a schematic diagram of an illustrative physical world for scanning a vehicle for placement into the metaverse in accordance with one aspect of the present disclosure;

FIG. 5 is a flow diagram showing exemplary processes for scanning a vehicle into the metaverse in accordance with one aspect of the present disclosure;

FIG. 6 is a schematic diagram providing a side-by-side comparison of a physical world vehicle and its scan into the metaverse in accordance with one aspect of the present disclosure;

FIG. 7 is a schematic diagram of the illustrative metaverse showing damage to a vehicle in accordance with one aspect of the present disclosure;

FIG. 8 is a schematic diagram showing an exemplary system for providing haptic feedback from the illustrative metaverse to physical world haptics in accordance with one aspect of the present disclosure;

FIG. 9 is a flow diagram showing exemplary processes for providing haptic feedback to the potential buyer in accordance with one aspect of the present disclosure;

FIG. 10 is a schematic diagram showing driving conditions while providing real-time feedback within the illustrative metaverse in accordance with one aspect of the present disclosure; and

FIG. 11 is a flow diagram showing exemplary processes for a test drive within the illustrative metaverse in accordance with one aspect of the present disclosure.

### DESCRIPTION OF THE DISCLOSURE

The description set forth below in connection with the appended drawings is intended as a description of exemplary embodiments of the disclosure and is not intended to represent the only forms in which the present disclosure may be constructed and/or utilized. The description sets forth the functions and the sequence of blocks for constructing and operating the disclosure in connection with the illustrated embodiments. It is to be understood, however, that the same or equivalent functions and sequences may be accomplished by different embodiments that are also intended to be encompassed within the spirit and scope of this disclosure.

The present disclosure relates to a virtual world where interactions between computer-generated participants or users may occur. More particularly, this disclosure describes a system within a metaverse that allows the participants to involve themselves in experiencing a vehicle through a dealership environment. In one illustrative embodiment, a metaverse server may be coupled to a client computer through a network with the client computer allowing a user to enter into the metaverse. The metaverse server may open the dealership environment within a metaverse application. The dealership environment may provide at least one vehicle in a context of a multidimensional virtual scene, wherein the at least one vehicle is replicated from a physical vehicle at a dealership. The system may include an object experience engine coupled to the metaverse application which provides interactions with the at least one vehicle from the dealership environment within the metaverse application.

Numerous other modifications or configurations to the vehicle experience system and method thereof will become apparent from the description provided below. For example, while the experience relates to vehicles, other types of mobility devices such as scooters and bicycles may be realized as part of this system. Campers, chairs, and power equipment may also be part of the experience and provided within the dealership environments. Advantageously, the experience provided by this system allows participants to realize product offerings virtually within the metaverse. Virtually any type of object may be part of this system. Other advantages will become apparent from the description provided below.

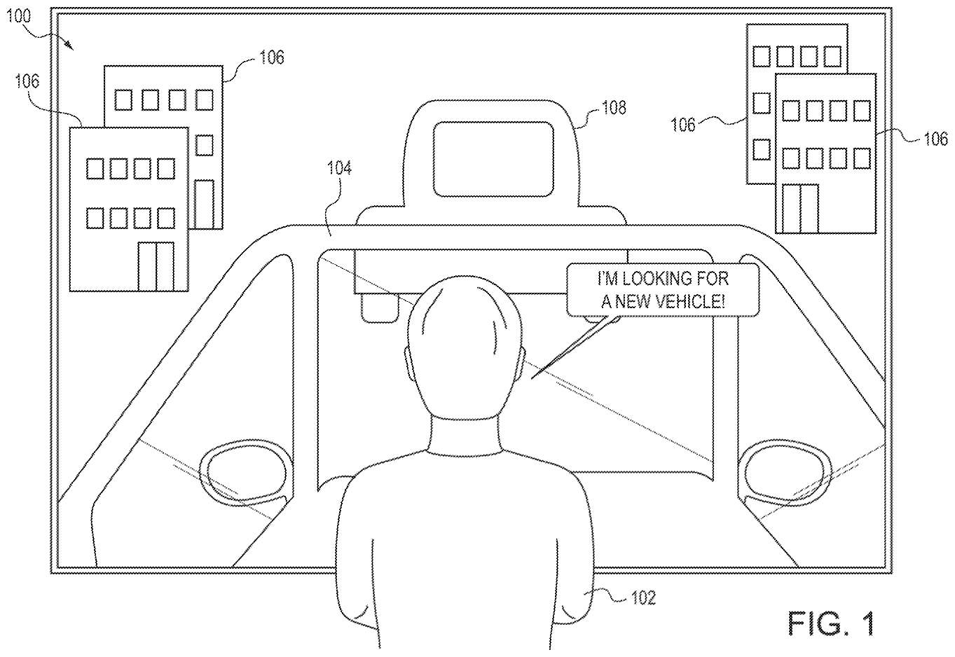

Turning to FIG. 1, a schematic diagram of an illustrative metaverse 100 whereby a potential buyer 102 queries for information regarding a new vehicle in accordance with one aspect of the present disclosure is provided. The metaverse 100 as typified in the shown embodiment may provide a highly immersive virtual world where participants may gather to socialize, play, and work. These participants may take the form of an avatar, which may be an icon or figure representing a particular person in the metaverse. The metaverse 100 may not be tied to a particular application such as a dealership environment, but rather may encompass many types of metaverse applications which are coupled to the metaverse 100. Metaverse applications may be part of the metaverse 100 which allows for their plug and play capability.

The metaverse 100 may be executed atop a metaverse server. An exemplary metaverse server may provide for a virtual world simulation through a software application that may be stored and executed on a computer 104. The server may facilitate tracking objects, including avatars, software agents, and inanimate objects associated with the recorded event. The metaverse server for the metaverse 100 may include an array of servers.

A specified area of the metaverse 100 may be simulated by a single server instance, and multiple server instances may be run on a single metaverse server. The metaverse server may include a plurality of simulation servers dedicated to physics simulation in order to manage interactions and handle collisions between characters and objects in a metaverse 100, as well as a plurality of storage servers, apart from the plurality of simulation servers, dedicated to storing data related to objects and characters in the metaverse world. The data stored on the plurality of storage servers may include object shapes, avatar shapes and appearances, audio clips, metaverse related scripts, and other metaverse 100 related objects.

The metaverse 100 may be coupled to a network where client computers 104 may access the metaverse 100. The network may communicate traditional block I/O over, for example, a storage area network (SAN). The network may also communicate file I/O, such as over a transmission control protocol/internet protocol (TCP/IP) network or similar communication protocol. In some embodiments, the computer network system may include two or more networks. In some embodiments, the client computer 104 may be connected directly to a metaverse server via a backplane or system bus. In one embodiment, the network may include a cellular network, another type of network, or a combination of networks.

Additionally, dealership servers may be connected through the network to the metaverse server. These dealership servers may record events in a standalone application such as purchases or leases made by the potential buyer 102. Furthermore, the dealership servers may be integrated into the metaverse 100 such that virtual objects may be displayed into the metaverse. These objects may be detailed within the dealership environment generated by the server and then placed into the metaverse where it may be tried and tested.

The client computer 104 described earlier may be used by the buyer 102 or participant for entering into the metaverse 100. As depicted in FIG. 1, the buyer 102 may be the focal point and views within the metaverse 100 are user centric. The client computer network system may interface a system user and the metaverse server according to the interface operations of a client computer. The computer network system may include the client computer 104, the metaverse server, and the network. Although the depicted computer network system is shown and described herein with certain components and functionality, other embodiments of the computer network system may be implemented with fewer or more components or with less or more functionality. For example, some embodiments of the computer network system may include a plurality of metaverse servers and a plurality of networks. Additionally, some embodiments of the computer network system may include similar components arranged in another manner to provide similar functionality, in one or more aspects.

The client computer 104 may manage the interface between the system user and the metaverse server. In one embodiment, the client computer 104 may be a desktop or laptop computer. In other embodiments, the client computer 104 may be a mobile computing device that allows a user to connect to and interact with a metaverse. The client computer 104 may be connected to the metaverse server via a local area network (LAN) or other type of network. The client computer 104 may run a virtual reality (VR) and/or augmented reality (AR) headset for immersion into the metaverse 100. This software and hardware may be run in tandem with the client computer 104 and the metaverse server. These may be provided in the form of headsets, googles, or the like.

In the shown metaverse 100, which is provided for illustrative purposes, the buyer 102 or user, may traverse through the virtual environment created by the metaverse server. The buyer 102 may connect into the metaverse 100 through their client computer 104 through the AR/VR headsets. A metaverse application as shown as the metaverse 100 may be simulated as a fully immersive three-dimensional (3D) virtual space that a user on a client computer 104 may enter as an avatar and interact with other avatars and objects in the metaverse via the metaverse client viewer. Thus, a plurality of users, each on their own client computer 104, may interact with each other and other simulated objects within the metaverse 100.

The 3D virtual space may show a buyer 102 traversing a road from a point of view of the buyer 102. The space generated by the metaverse 100 may show a number of buildings 106 that may represent services or products. The buildings 106, or other storefronts, may provide advertisements on front of their space as an example. Trademarks, logos, or other iconography may be displayed on the buildings 106. Branding in the form of actual storefronts such as Honda may be placed in the metaverse 100.

The metaverse 100 may also include other participants within the virtual world. These participants may be placed in other vehicles 108, walk on the side of the street, be within the buildings 106, etc. In some embodiment, non-player characters (NPCs) may be positioned within the metaverse 100. Their functionality and roles may be limited and may be operated by computer generated behaviors. Idle participants who are no longer online or have stopped interacting with their client computers 104 may also be part of the metaverse 100. In some embodiments, these participants may be taken out of the metaverse 100.

In the vehicle experience system developed within the metaverse 100, the buyer 102 may be looking for a vehicle. This may be known to others within the metaverse 100 by the buyer 102 typing in the through a search tool “I'm looking for a new vehicle!”. Alternatively, the potential buyer 102 may be looking for a new vehicle when their own vehicle breaks down. Other cues for understanding whether a user may be in the market for a new vehicle is how old their current physical vehicle is, how many miles it has, the condition it is in, for example. The potential buyer 102 may also be interested in a new vehicle for example when a child graduates from high school as a gift. Other occasions and events may warrant to display vehicles and dealerships within the metaverse 100.

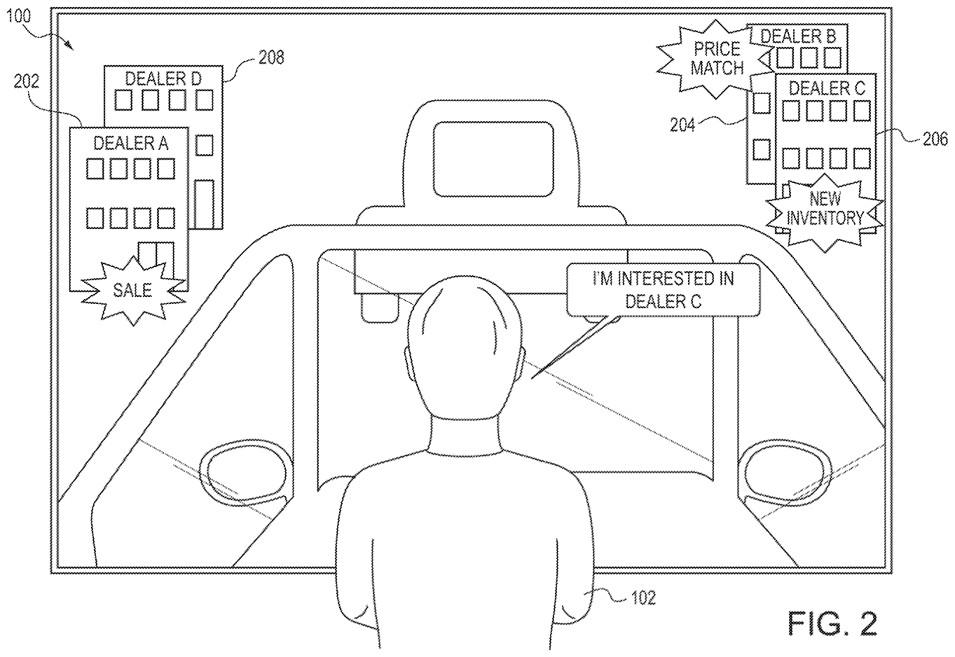

FIG. 2 is a schematic diagram of the illustrative metaverse 100 where geographically proximate dealerships 202, 204, 206, and 208 provide information regarding a new vehicle in accordance with one aspect of the present disclosure. Dealership information may be displayed after the query provided above or through other described method. The buyer 102 may be presented with information based on dealerships that are close to the buyer 102 and their location in the physical world, for example. Alternatively, the buyer 102 may be presented with dealership options that are not geographically close. In one example, the buyer 102 may be given dealership options that are close to where they are traversing in the metaverse 100. The buyer 102 may have travelled a large distance away into another virtual area where the physical dealership is not close. This information about the proximity of the dealership may be provided to show how this would affect cost such as shipping the vehicle to the buyer 102.

The potential buyer 102 may view a number of dealerships 202, 204, 206, and 208 around them. The buyer 102 may make their own selection on which dealership 202, 204, 206, and 208 to visit. Each of the dealerships 202, 204, 206, and 208 may be tied to a physical location and may have physical inventory. Each dealership 202, 204, 206, or 208 may have their own environment within the metaverse 100.

The dealership environment may be used to make an engagement with customers in the metaverse 100. The vehicle dealership may engage a customer database within the metaverse 100 to provide quotes for a vehicle and shows their specific inventory according to the customer needs. In one example, Dealership A 202 may be displayed. Dealership A 202 may display information about the specific vehicle that the buyer 102 is looking for or their entire inventory be displayed. The depiction shown for Dealership A 202 within the metaverse 100 may be of a building that the particular brand is known for, that is, the trade dress or branding of the particular dealership may be used in the metaverse 100. A list of vehicles for sale may be shown for Dealership A 202 and may be explored within the metaverse 100 through slide and selection inputs made by the user through their client computer.

Dealership B 204 may provide information about the vehicle that the buyer 102 is interested in. In one embodiment, Dealership B 204 may provide for price matching. Dealership B 204 may take the form of its own branding guidelines and show vehicles related to their specific manufacturer. The Dealership B 204 may run atop a separate metaverse application that is different from Dealership A 202, but both may be connected into the metaverse 100.

Dealership C 206 may show new inventory within the metaverse 100. Each of the dealerships 202, 204, 206, and 208 may run in their own environment and may be separate from the metaverse application. Alternatively, the dealerships 202, 204, 206, and 208 may be a part of the metaverse application and run within the metaverse server. For example, the dealership environment may be an extension of the metaverse 100 by using application protocol interfaces (APIs) or software development kits (SDKs) by the metaverse server. Alternatively, the dealerships 202, 204, 206, and 208 may be built directly into the metaverse 100 and use the platform presented by the metaverse server.

Dealership D 208 may also be shown in the metaverse 100. Dealership D 208 may show other pertinent information not provided by the other dealerships 202, 204 or 206 that the buyer 102 may be interested in.

In one embodiment, the potential buyer 102 may search through all OEMs in a room, or resort to the illustration described above. Once an OEM is selected, multiple dealers may provide quotes for a vehicle and show their specific inventory.

After a dealership 202, 204, 206 or 208 has been selected, replicas of the vehicles within a dealership's inventory may be provided within the metaverse 100 and the buyer may take a test drive. The vehicles that are shown may be replicas of those vehicles that are physically within the inventory of a dealership 202, 204, 206 or 208.

After selecting a dealership 202, 204, 206 or 208, the potential buyer 102 may enter into the dealership environment. For example, the buyer 102 may provide that “I'm interested in Dealer C”. The buyer 102 may enter into that dealership by either selecting the dealership, looking at it and selecting, or providing visual/audio confirmation. In one embodiment, the metaverse 100 may allow the user to walk to the dealership through traversing the streets and the roads. This may be done through some type of scroller, keyboard, or similar controller associated with the client computer.

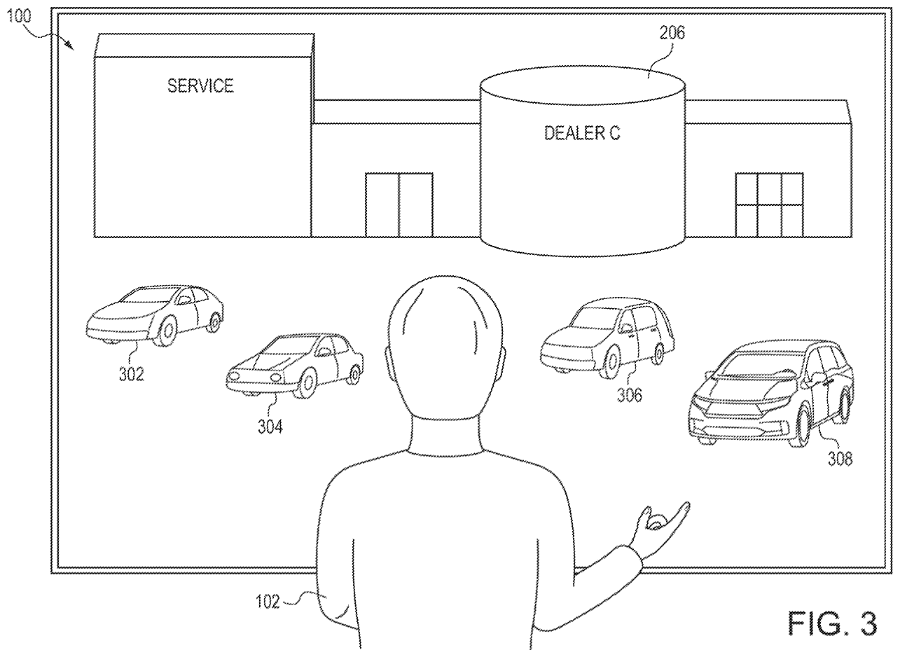

With reference to FIG. 3, a schematic diagram of the illustrative metaverse 100 after selection of a dealership 206 by the potential buyer 102 in accordance with one aspect of the present disclosure is provided. Beforehand, it was shown how the metaverse 100 allows a buyer 102 to search for a vehicle in the metaverse 100. The potential buyer 102 may select an OEM for the vehicle or multiple OEMs that may send their quotes. Specific inventory may then be provided to the buyer 102.

Through the metaverse 100, and the vehicle experience system described herein, the buyer 102 may have the ability to drive replicas of vehicles 302, 304, 306, and 308 that are in the physical world and associated with the dealerships. The vehicles 302, 304, 306, and 308 may take the form of sedans, coups, trucks, sports utility vehicles, and the like. Other types of sale and/or leased products may also be shown by the dealership 206 and not necessarily limited to those shown within this illustration.

The dealership environment 206 may run atop the metaverse application. The dealership environment 206 may show specific vehicles 302, 304, 306, and 308 that are actually in the inventory of the dealership. Vehicles not within the dealership's inventory may not be shown. The displayed vehicles 302, 304, 306, and 308 may show any imperfections or other damage as they mimic the physical world vehicles.

In one embodiment, the metaverse 100 may provide a user interface for scrolling through the virtual vehicles 302, 304, 306, and 308 more effectively and efficiently. For example, the color of the vehicles 302, 304, 306, and 308 may be changed through swiping or clicking. Other options may be added to the vehicles 302, 304, 306, and 308 such as accessories provided by the dealership 206. The vehicles 302, 304, 306, and 308 that would be shown would be those that are on the dealership lot, or at least physically obtainable by the dealership 206.

In one user interface, the potential buyer 102 may be able to swipe back and forth the different models. The user may swipe left/right and/or up/down to locate a vehicle within the inventory that they are interested in. For example, when swiping left/right, different colors of the same model may be shown. Swiping up/down may cause the inventory of vehicles to add/delete different versions of the model. Additional information may also be presented on the metaverse 100 regarding the vehicles 302, 304, 306, and 308 such as miles, maintenance history, damage/accidents, body repairs, ownership, and the like.

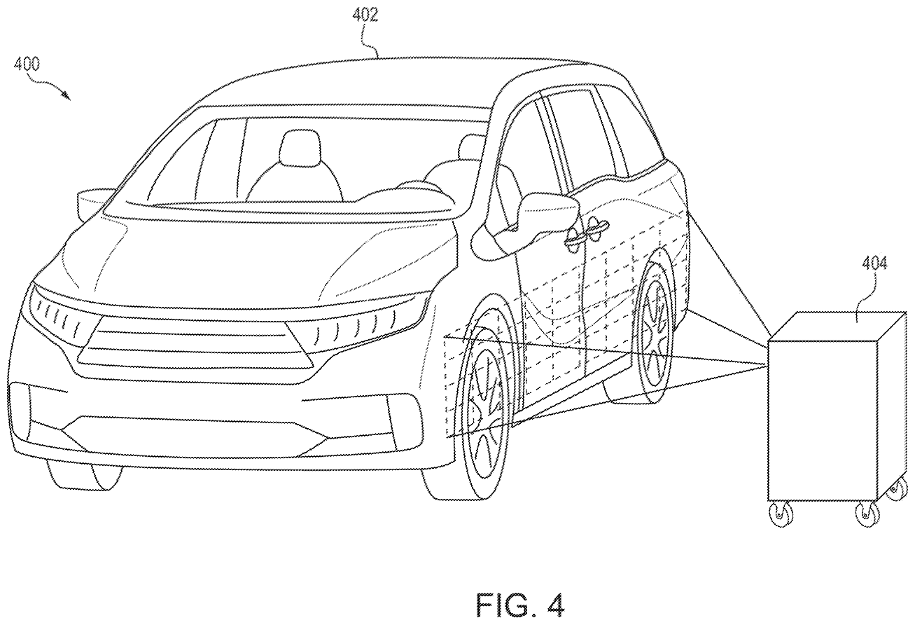

Advantageously, the vehicle experience system hosted in the metaverse 100 may use real-time information regarding the vehicles 302, 304, 306, and 308. FIG. 4 is a schematic diagram of an illustrative physical world 400 for scanning a vehicle 402 for placement into the metaverse in accordance with one aspect of the present disclosure. The key component for providing information into the metaverse is having real world physical objects that may be scanned into the metaverse.

The physical vehicle 402 may be scanned into the metaverse through a camera 404. The vehicle 402 may be scanned into the metaverse to show real-time flaws, issues, or other concerns that a potential buyer may be interested in. This information may be verified through the metaverse. Verification may include using verified cameras 404 and/or using only authorized and trusted dealerships, for example.

Information about a model, year made, and/or title owner may be attached with the scan from the camera 404. When replicated to the metaverse, these parameters and information may be stored by the dealership environment which may be on the dealership's server or the metaverse server.

The replicated vehicle within the metaverse may be generated through the use of these parameters, information, and scans. A generic vehicle model noted with make/year may be created. The model may then be modified through those parameters. In an example, a generic Honda CR-V may be placed into the metaverse. The scans including those parameters may then be used to alter the generic model.

Turning now to the specifics, the camera 404 may be used to scan the physical world vehicle 402 into the metaverse. The camera 404 may operate in the physical world 400. The camera 404 may be set on a tracks which rotates the camera 404 around the vehicle 402. The camera 404 may include optics, acoustics, or the like to scan the vehicle 402. The camera 404 may be raised or lowered such that a 360 degree outer view of the vehicle 402 may be captured. Underneath the vehicle 402 may be inspected and scanned as well.

Information and/or parameters gathered from the camera 404 may be stored on the dealership server and/or metaverse server. Multiple cameras may be used for the system and may capture 3D effects. While the camera 404 was described as being tethered to a track system around the vehicle 404 or was able to be placed around the vehicle 404. The camera 404 may be traversed around through a trackless system around the vehicle 402. Other systems for maneuvering the camera 404 may include those that are in flight. The camera 404 may be flown around the vehicle 402 to capture its details.

The vehicle 402 may be scanned on the interior as well. Wear and tear inside the vehicle 402 may be determined to give a more accurate representation in the replica of the vehicle in the metaverse. The camera 404 may be used to check for scratches and/or dents. Those blemishes or conditions that are different from a normal vehicle would be noted as a parameter, the parameters being capable of being loaded into a generic model within the metaverse. Scans of the engine compartment may also be made.

Other parameters that may be scanned from the physical vehicle 402 may include performance factors. For example, running parameters of the vehicle 402 may be checked. This information may be communicated through the vehicle's transmission control unit, or other transmission capability of the vehicle 402. These parameters may show how the vehicle runs and operates. In one example, these parameters may include how the vehicle 402 accelerates, stops, turns, and the like. Other information may include miles per gallon. Miles per gallon may also be broken into how the vehicle 402 operates while driving on a highway and urban conditions. Other conditions affecting the vehicle 402 and its operation may include weather conditions. All of these parameters may be packaged and provided to the dealership environment and stored on the dealership server. This information may be communicated to the metaverse server when the object vehicle is operated in the metaverse.

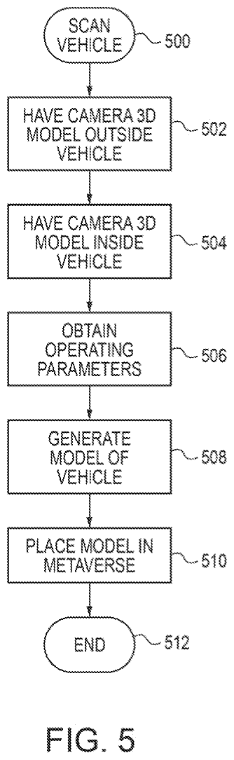

FIG. 5 is a flow diagram showing exemplary processes for scanning a vehicle into the metaverse in accordance with one aspect of the present disclosure. These processes are directed to scanning of the vehicle and obtaining parameters such that the physical world vehicle may be replicated into the metaverse. The processes may begin at block 500.

At block 502, a camera or other sensing device may be used on the outside of the vehicle that replicates the physical world vehicle into the metaverse and into the dealership environment. 3D models of the vehicle may be generated from the scan. The camera may be used to scan the interior of the vehicle at block 504. This scan may be taken from cameras within the vehicle or cameras that may be placed in the vehicle. At block 506, operating parameters may be obtained. These may include how the vehicle performs and runs. As a non-limiting example, the acceleration, turn radius, weight, handling, etc. of the vehicle may be determined.

At block 508, a model of a replicated vehicle is generated. In one embodiment, this may begin by taking a clean model of a normalized vehicle. For example, a Honda CR-V may be taken that is clean and has no modifications or updates. Parameters that were scanned in or taken earlier may then be applied to update the vehicle such that the vehicle now is a replication of the vehicle in the physical world. This may include placing any damages, dents, or other issues within the vehicle both on the exterior and the interior.

At block 510, the generated model may be placed into the metaverse. The dealership environment may take the generated model and store it. The model may be stored until sold or leased. Digital assets such as the vehicle are thereby created and maintained. The processes may end at block 512.

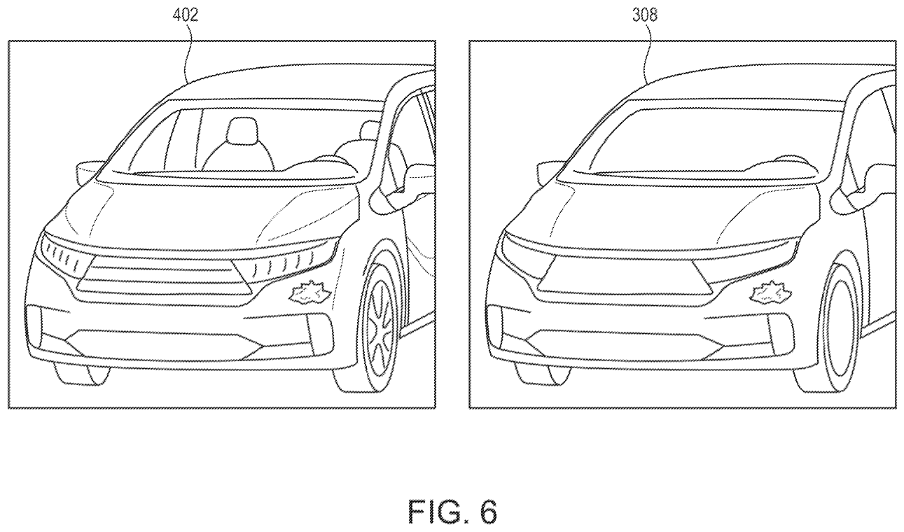

Now referring to FIG. 6, a schematic diagram providing a side-by-side comparison of the physical world vehicle 402 and its scan into the metaverse in accordance with one aspect of the present disclosure is provided. The vehicle 308 as portrayed in the metaverse is shown on the right hand side while the physical world vehicle 402 may be portrayed on the left. The physical world vehicle 402, as opposed to the metaverse vehicle 308, may have more of a real world look as opposed to a cartoonish look. As shown, the damage on the physical world vehicle 402 has been properly translated to the metaverse vehicle 308 through the scanning. The side-by-side comparison may be made both internally and externally. The metaverse may allow for traversing in, out, and around the vehicle 308. As such, the metaverse vehicle 308 may be one that mimics the physical world vehicle 402.

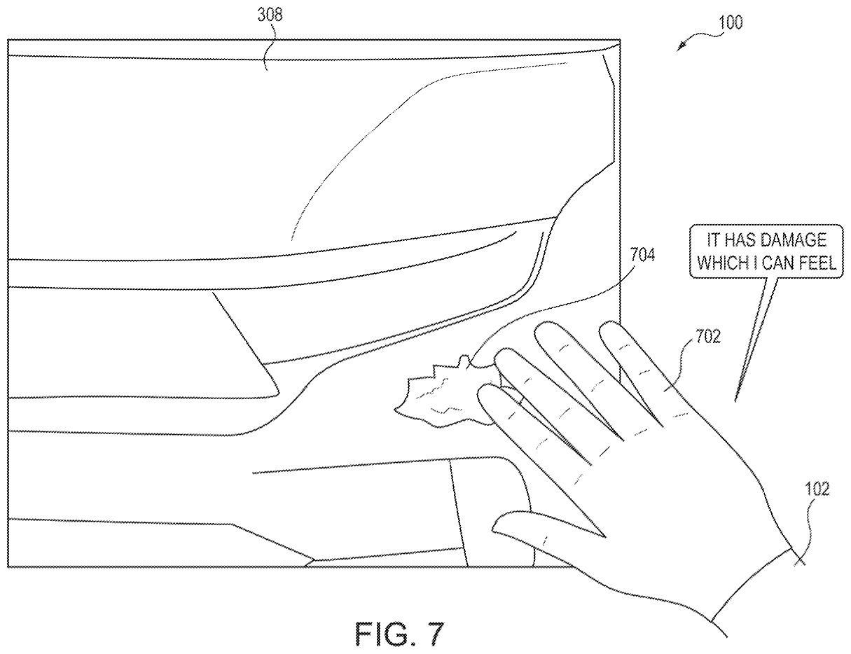

FIG. 7 is a schematic diagram of the illustrative metaverse 100 showing damage to the vehicle 308 in accordance with one aspect of the present disclosure. Beforehand, the vehicle 308 within the metaverse 100 was able to be replicated into the metaverse 100 through a set of parameters scanned from a physical world vehicle associated with a dealership. The parameters were applied to a generic model of a vehicle and then recreated into the vehicle 308 shown in the metaverse 100. In an illustrative example, the vehicle 308 shown has damage to a front end the vehicle 308.

In the metaverse 100, it may be difficult to actually feel anomalies or issues with the physical world vehicle. As such, and through the vehicle experience system described herein, the potential buyer 102 may be able to realize the damaged area 704 through a special or dedicated handset, such as a glove 702. The glove 702 may provide real time haptic feedback as the buyer 102 places their hand over the damaged area 704. The grooves or indents within the damaged area 704 may be sensed through the glove 702.

In one illustrative example, the glove 702 may be a wearable device that allow a user to experience realistic touch and interactions through advanced tactile feedback. When actuated, haptic sensors within the gloves may recreate a realistic sense of touch for users. Typically, haptic gloves 702 may use a pattern of actuators to simulate the feel of tactile feedback for the wearer. The more actuators on the glove 702, the more precise and realistic the feedback is. The buyer 102 may wear gloves 702 that may mimic the touch and feel of the actual damage of the vehicle and it may be touched over and over. The powerful combination of finger tracking gloves 702 with haptic feedback may make it possible to accurately feel 3D objects in the metaverse.

The glove 702 may also be used to provide real time feedback while the buyer 102 is within the vehicle. For example, rolling down the windows, steering the wheel, and other motions within the vehicle 308 may be given haptic feedback. The glove 702 may provide enough feedback and pushback such that the potential buyer 102 would believe that they are in the physical world vehicle but yet be driving the vehicle 308 in the metaverse 100.

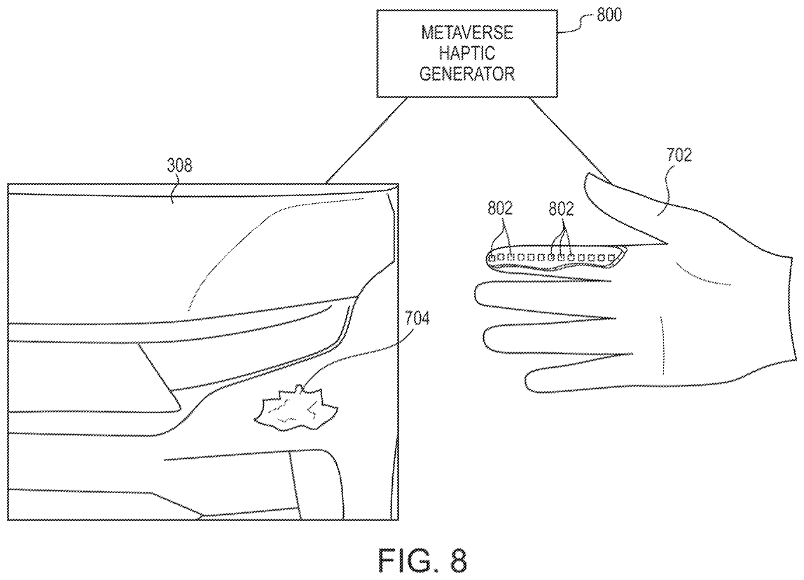

FIG. 8 is a schematic diagram showing an exemplary system for providing haptic feedback from the illustrative metaverse to physical world haptics in accordance with one aspect of the present disclosure. The vehicle experience system may use gloves that mimic the touch and feel of the actual damage to the physical vehicle. The haptic and sensory feedback may extend beyond gloves. For example, head mounted feedback may be provided. This feedback may be used when the user turns the vehicle.

A vehicle seat and/or headrest may be used to provide this type of feedback. These may be recreated or a current physical vehicle may be used. Steering wheel haptics may also be provided along with shifters, actuators, and other devices associated within a typical vehicle. A number of haptic devices are within the scope of this disclosure and are not limited to those described above.

Other sensory feedback devices may also be used in tandem or alone to provide those users in the metaverse with a real and actual feeling that they are driving in the physical world. These may include audio sound clips. Screeching tires, walking signals, other pedestrians or vehicles, and the like may all be integrated into the audio clips. Wind sensations may also be mimicked from the physical world into the metaverse. Each of these may provide a real world experience for the potential buyer.

As shown, a metaverse haptic generator 800 may be used in combination with the metaverse application and the dealership environment. The generator 800 may be dealership specific or may be tied into the metaverse server. The primary purpose of the metaverse haptic generator 800 may be to correlate an action between a user and their placement within the metaverse, and the interactions that the user has within the metaverse. This may use a direct placement of the user within the metaverse and how they interact with objects.

In the shown illustration, the glove 702 described earlier may provide haptic feedback. The feedback may be given through haptic actuators 802. The illustration shown provides for a cut out portion which shows those actuators 802. These actuators 802 may provide varying levels of feedback and may be coordinated with one another through the metaverse haptic generator 800. For example, if the user slides their hand across the damaged areas 704 of the metaverse vehicle 308, the haptic actuators 802 would run accordingly along the glove 702. That is, the actuators 802 with varying degree would mimic the user's hand sliding across.

The mimicking may also occur outside damaged areas 704. For example, the user may slide their hands across non damaged areas, around the fender, within the vehicle, and along cloth/leather seats. The purpose of the glove 702, and other devices, may allow the user to simulate objects in the metaverse to those of the physical world.

In one embodiment outside the dealership experience, a private sale may occur between two or more parties. The glove 702 may be used by one party to provide information into the metaverse haptic generator 800 and the other party may use another glove 702 to receive the haptic feedback. The sale may be outside a vehicle context as well. Virtually any objects may be scanned in where haptic feedback may be provided through the metaverse.

In mechanic applications, the glove 702 may also be used by a mechanic to determine where an issue lies within a vehicle. The vehicle may be scanned into the metaverse and be represented as a virtual vehicle 308. The internal components are mainly scanned in. The mechanic may then use their glove 702 to determine the issue or issues with the vehicle through the virtual vehicle 308. The mechanic may then provide a quote on how much the vehicle might cost to repair. Further, the mechanic may pre-order parts to speedup the process of repairing it.

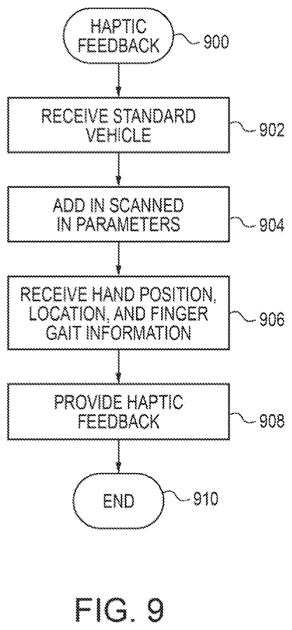

FIG. 9 is a flow diagram showing exemplary processes for providing haptic feedback to the potential buyer in accordance with one aspect of the present disclosure. While the use of a glove is shown, other types of haptic and sensory feedback systems may be used such as body suits, seats, steering wheels, fans, and the like. The processes may begin at block 900.

At block 902, and for purposes of providing real-time feedback from the physical world vehicle as mimicked by the metaverse vehicle, standard information about a vehicle may be received and recreated in the metaverse. At block 904, parameters providing information about the physical world vehicle are used to change the standard model of the vehicle in the metaverse. This may include scanned in damages or blemishes from the physical world vehicle.

A hand position, location, and finger gait information are received at block 906. This information is correlated with the metaverse application through the metaverse server. This information may be used to determine where and how much haptics to provide. This typically occurs instantaneously. The metaverse haptic generator may then provide haptic feedback at block 908. This may provide real-time feedback on the glove, or other device. The processes may end at block 910.

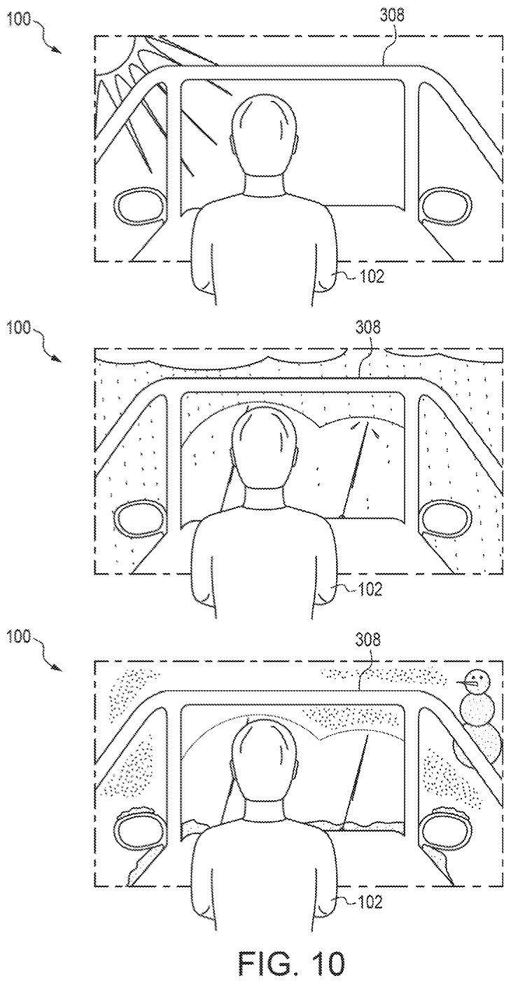

With reference to FIG. 10, a schematic diagram showing driving conditions while providing real-time feedback within the illustrative metaverse 100 in accordance with one aspect of the present disclosure is provided. The prospective buyer 102 may traverse the metaverse 100 in different weather conditions, terrains and the like. The metaverse 100 may place the vehicle 308 in sunny, raining and snowy conditions. Other conditions such as mountains, flat, hilly, and the liked may also be part of the metaverse application run atop the metaverse sever. Test drives may be made in these different scenarios with provided haptic feedback.

The metaverse application may work in combination with the dealership environment. The dealership environment may be generated through an API/SDK provided by the metaverse application or may be programmed within the metaverse 100. The dealership environment may hold the vehicle and/or object that the potential buyer 102 is interested in. From there, the metaverse vehicle 308 may be placed from the dealership environment to the metaverse. The metaverse may provide more scenarios and different sceneries than the dealership environment. As such, the metaverse application may be a true test of the metaverse vehicle replicated from the physical world vehicle.

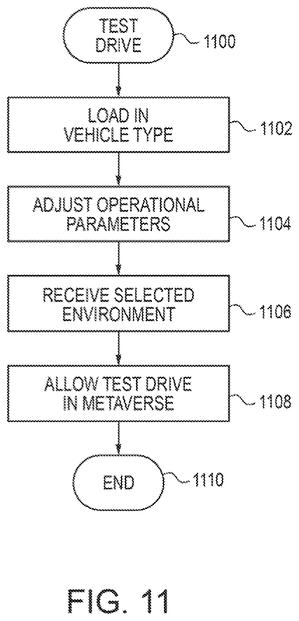

FIG. 11 is a flow diagram showing exemplary processes for a test drive within the illustrative metaverse in accordance with one aspect of the present disclosure. The processes may begin at block 1100. Test drives may be made in different scenarios as described above. At block 1102, a vehicle type may be loaded in. This may be a generic vehicle platform for which parameters may be later loaded into. The base system or template may not have blemishes.

At block 1104, the base model may be adjusted to parameters on both the interior and exterior. These parameters may modify the particular base settings. For example, if a scratch is on the vehicle, this may be recreated on the base model. Color and other configurations based on the physical world vehicle may also be replicated on the base model.

At block 1106, the metaverse application may receive the selected environment to place the updated metaverse vehicle in. This may include a number of different environments to test how the real world vehicle performs as replicated by the metaverse vehicle. The potential buyer may test drive the vehicle in the metaverse at block 1108. This may include the potential buyer getting in their own vehicle, or a mock up of one, putting on their AR/VR headset and then running the metaverse vehicle in the metaverse. This may require the dealership environment to pass the object to the metaverse application where it may run atop of.

After completing the test drive with the metaverse vehicle, the vehicle may be returned to the dealership environment. In one embodiment, the metaverse vehicle may only be used on one instance at one time. This may prevent the vehicle from being purchased or leased multiple times. Alternatively, it may be used multiple iterations. The processes may end at block 1110.

The foregoing description is provided to enable any person skilled in the relevant art to practice the various embodiments described herein. Various modifications to these embodiments will be readily apparent to those skilled in the relevant art and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

1. A system, comprising:
a first client computer coupled to a network;
a metaverse server coupled to the first client computer through the network, the metaverse server opening an environment within a metaverse application, the environment comprising at least one virtual object in a context of a multidimensional virtual scene, wherein
the at least one virtual object replicates a physical object in real world,
the at least one virtual object comprises a base model, and
an appearance of the base model is modified based on a scan of the physical object to replicate an appearance of the physical object in the real world; and
an object experience engine coupled to the metaverse application, the object experience engine providing interaction with the at least one virtual object for the environment within the metaverse application.

2. The system of claim 1, wherein the first client computer comprises a virtual reality (VR) or augmented reality (AR) headset displaying the metaverse application.

3. The system of claim 1, further comprising a second client computer coupled to the metaverse server through the network, wherein the environment is a dealership environment that operates through the second client computer.

4. The system of claim 3, wherein the dealership environment within the metaverse application is executed by a dealership server separate from the metaverse server.

5. The system of claim 1, wherein the at least one virtual object comprises at least one of a power equipment, a vehicle, a trailer, or a mobility device.

6. The system of claim 1, wherein the at least one virtual object is multidimensional.

7. The system of claim 1, wherein the physical object is scanned into a metaverse associated with the metaverse application and stored in the environment.

8. The system of claim 7, wherein scanning the physical object into the metaverse comprises surveying inside and outside of the physical object.

9. The system of claim 1, wherein the interaction comprises different weather scenarios.

10. The system of claim 1, wherein the interaction comprises driving the at least one virtual object in the metaverse application, the object experience engine receiving parameters based on the physical object to generate the interaction.

11. A computer program product comprising a non-transitory computer useable storage medium to store computer readable instructions that, when executed on a computer, causes the computer to perform operations comprising:
storing information of at least one vehicle scanned in from a physical world vehicle, wherein
the stored information is associated with a dealership environment within a metaverse application,
the at least one vehicle comprises a base model, and
an appearance of the base model is modified based on a scan of the physical world vehicle to replicate an appearance of the physical world vehicle;
receiving an event within the metaverse application regarding the at least one vehicle provided by the dealership environment; and
providing an experience within the metaverse application regarding the at least one vehicle from the dealership environment in response to the event.

12. The computer program product of claim 11, wherein the computer readable instructions, when executed on the computer, causes the computer to perform the operations to receive an offer for the physical world vehicle.

13. The computer program product of claim 11, wherein the stored information of the at least one vehicle comprises driving parameters.

14. The computer program product of claim 13, wherein the driving parameters modify the experience within the metaverse application.

15. The computer program product of claim 11, wherein the experience that is provided within the metaverse application comprises providing haptic feedback that corresponds with the physical world vehicle.

16. A metaverse server, comprising:
an environment within a metaverse application, the environment comprising at least one virtual object, wherein
the at least one virtual object replicates a physical object in real world, the at least one virtual object comprises a base model, and
an appearance of the base model is modified based on a scan of the physical object to replicate an appearance of the physical object in the real world; and
an object experience engine coupled to the metaverse application, the object experience engine providing interaction with the at least one virtual object in the metaverse application.

17. The metaverse server of claim 16, wherein the environment is a dealership within the metaverse application.

18. The metaverse server of claim 16, wherein the interaction allows the at least one virtual object to be used in the metaverse application.

19. The metaverse server of claim 16, wherein the interaction allows a user to receive haptic feedback.

20. The metaverse server of claim 19, wherein the haptic feedback is provided by a glove.
